(19) United States
(12) Patent Application Publication
(10) Pub. No.: US 2008/0301154 A1
(43) Pub. Date: Dec. 4, 2008

(54) USER DRIVEN, INTERACTIVE, INTELLIGENT AND ADAPTIVE MANAGEMENT AND BUSINESS INTELLIGENCE DATA RETREIVAL AND VIEWING INFORMATION SYSTEM AND TOOL, THAT IS DATABASE OR DATA SOURCE ABSTRACTED AND INDEPENDENT, AND IS NETWORK AND CONNECTIVITY ABSTRACTED AND INDEPENDENT, WITH ADMINISTRATIVE SUPPORT

(76) Inventor: JOSEPH VITHAYATHIL, Irvine, CA (US)

Correspondence Address: JOSEPH VITHAYATHIL, 5511 VERANO PLACE, IRVINE, CA, 92617, US

(21) Appl. No.: 11/738,243

(22) Filed: Jun. 2, 2007

(51) Int. Cl. G06F 17/30

(52) U.S. Cl. 707/100; 707/E17.001

(57) ABSTRACT

A software tool or information system that is User Driven and allows the user to imagine, dictate, iterate and control the place, means, format and kind of data and information to be viewed and analyzed. The system allows the User to begin with an imagined image or picture of what is required. The system is Interactive and allows the user to iterate, change, modify improve, edit, correct, consolidate, drill down and perform all other actions that are required by the user. The system is Adaptive and has a learning capability that will anticipate and prompt progressively more accurately what the User desires from the User's inputs and therefore Adapts to the User. The System is Adaptive, Learning with intelligent estimation of the User's request when examining the target database or data source. The system is also Database or Data Source Abstracted and Independent by automating the query, search and seek process and by automatically generating all required actions including the appropriate code generation, including all query code and the abstraction of the key elements of database parameters and characteristics supplemented by a target specific element. The system also incorporates Network and Connectivity Abstraction and Independence. The System is supported by automated and Intelligent Administrative functions.

### FIELD OF THE INVENTION

The invention described herein is in the general field of information systems, business management and/or business intelligence and includes software, computer and network based information systems. The invention is in the architecture of an information system that, based on software, runs on computers, servers and networks, is intelligent, adaptive, and is completely controlled by the user. The applications include any type of organization or institution that needs to review, analyze and use data for the purpose of management and running of said organization or institution, which can include the broadest definition of an organization or institution and includes small and large companies, private and public, for-profit or non-profit, educational or business, domestic or international, as an individual business entity or partnership, or any type of registered or un-registered business or organizational entity, in other words, any organization that uses and/or generates or uses or generates data in its operations.

The invention also uses data sources such as standard databases or Relational Data Base Management Systems (RDBMS) or Object Oriented Database Management Systems or any other kind of data sources where data is stored and where the logical form of the data is typically represented in tables. However, the system described herein can also apply to data that is not typically stored in tables and stored in any other manner such as video or audio files or any other means. Data sources also include data warehouses and other means of storing and retrieving data and includes real time, non-real time data and data that is on line and nearly on line and data that is back up and data that is archival. This also covers data stored in any kind of physical format including various kinds of semiconductor memory, disk drives, tape drives, optical media, magnetic media and any other kind of physical or biological or biochemical, biomechanical or micro-mechanical media.

### BACKGROUND OF THE INVENTION

Even though there have been tremendous improvements in three physical areas that support information systems namely computing power, memory size and access and network bandwidth there has not been a corresponding dramatic change in the way users can filter, access, display, modify, iterate, and present information for the purposes of running an organization where such activity can be driven and controlled by the user who is non-technical and only has the basic abilities of managing a typical browser or ms-office type of interface.

Organizational information management systems have evolved form the early punch card based, batch oriented systems to on-line systems to today's enterprise systems such as those from Oracle™, SAP™ and others. These involve
data sources such as databases or data warehouses
a variety of Structured Query Languages (SQLs)
programs and applications to access and manipulate this data
programs and applications to network this data
programs and applications to administer this data
programs and applications to generate reports
programs and applications for a multiplicity of databases, networks, end user systems

The complexity is large and evident and the user has no control on the information and no ability to customize individually, and the various pieces do not provide any ability to isolate and immunize the user from the variety of databases, programming languages, networks, administrative requirements, end user hardware and software environments.

While the hardware in terms of semiconductors, computer, and networking systems have evolved rapidly in performance, the tools for managing a business have not evolved. Functional tools that leverage hardware have evolved and examples of these are customer service voice-recognition tools used by airlines and others. Other specific functional tools are search tools. Business management examples of specific functional tools are what are termed as “add-on” or “extension” tools such as those provided by “business intelligence” companies such as Business Objects™ and its toll call Crystal Reports™. This tool is an extension to a spreadsheet and allows the user to manipulate data that is already moved to a spreadsheet such as Microsoft's Excel™.

However, in a real business environment, the data typically resides in a data base system that may by operational, archival or other. This data cannot be accessed and manipulated by a user at will, in real time, or almost real time. Intermediaries are needed and typically they are the purveyors of the database or Enterprise Resource Planning (ERP) systems or they are consulting companies such as KPMG™ and for a fee, they will come in as consultants, attempt to understand what the user wants—at that point in time—and provide custom tools to generate what the user wants. However, at the end of the day, the user has no control to change, modify or create his/her own reports, charts, views, and iterate them at any time, in any place in any manner.

A further limitation of the custom tools is that they are also subject to the networking requirements and are limited to a particular database or a particular environment. They cannot be moved from company to company and do not have the necessary administrative sub-tools.

Thus, they do not have
database abstraction and independence
network independence
software and hardware infrastructure independence

Moreover, most of all, cannot be controlled, changed or manipulated by the user at will, from anywhere, in any manner.

For example, the user desires to see the sales data for the past 12 months for a product within a region. Then, look at other regions, compare pricing between regions and then having seen a potential problem with the margins of a certain product, call up another table to look at the cost elements of that specific product for the last 12 months, then zoom in on the week that costs seemed to have spiked up, then call for the bill-of-materials and identify exactly where the problem came from. The user should be able to do this all in real time from the corporate system, without speaking to any IT person. The user should be able to view the data as tables or graphs or charts in any of the typical forms that are generally used and should be able to change the views simply by using a drag and drop scheme for the desired headings. In essence, the user simply needs to think—this is what I want to see—and with simple drag and drop prompts, coupled with some typing of the headings (or labels), the software system described by this patent application will go into the network, get to the database and bring back exactly what the user desired, a) all without any Information Technology (IT) personnel intervention. Nothing can do this today.

The invention described herein provides the architecture to address all of the above.

### SUMMARY OF THE INVENTION

The system and product that is embodied by the architecture in this patent will allow any business or organization to Access, Create and View any and all types of business data that can be imagined by the user. The conventional means by which data is viewed has not changed and they are broadly
Either tables (with rows and columns) typically two dimensional, sometimes three dimensional (higher dimensions cannot be viewed in a three dimensional space that we live in, but have to be reduced)
Or charts and graphs, such as bar charts, line graphs, pie charts and many other such form of charts.
Such charts or tables can be stacked, linked, stored, edited, modified, enhanced and operated on in multiple and various ways and means.

The business user typically imagines a table or chart and goes on the different views, and cuts at data to perform normal business activity such as looking for problems, preparing reports, analyzing trends, checking on product sales, looking at supplier quality, supplier delivery time as a handful of examples from thousands of such possible activity or actions. The users experience is enhanced by animation, drag & drop, visual aids

It is equally important to understand what the user does not need, does not need to do or does not need to get done by third parties or IT personnel. The most relevant examples are
Get a programmer for retrieving data, displaying, analyzing and reporting
Write SQL code
Transcribe database information into Excel or some other spreadsheet
Write Excel Macros
Deal with erroneous data
Look at data table entries in cryptic programming jargon or labels

These are just some of the common actions that are needed by conventional systems.

Some of the elements of what the user needs are delineated more below as what the user does need
Request information and the format or dashboard for display
Tables or Chart form
The software extracts the data from the database
The software translate the data into the format desired
The software automatically does all code generation
The software process and display in the format or dashboard required
Ability to modify
Ability to aggregate
Ability to drill down selected or chosen attributes
Make real time changes as the user desires
Have drag & drop change capability
Have graphic ability (circle, highlight, emphasize . . . )
Have animation capability
Have drill down capability
Have portability to Excel, PowerPoint, Word
Have web capability
Have browser capability
Data be intelligently translated to common business labels or headings
If erroneous data found, ability to update database
Intuitive front end that requires literally no training other than business knowledge

However, this is just the user facing aspect of the whole system. There other key elements which are a) the ability to abstract from particular and specific data sources such as a database or a data warehouse and b) the ability to learn and interpret the users requests c) the ability to perform administrative tasks for the system, such as keeping track of licensed users, the billing arrangements, performance of the system, access and others d) the ability of the system to be Operating System and Hardware agnostic e) the ability to be network transparent such that it can be accessed in a secured LAN (Local Area Network), or anywhere in the world on browser via VPN (Virtual Private Network) or other secure means, all of which can be wired or wireless and can be new generation packet based or old generation TDM (Time Division Multiplexed) based or any kind of next generation networks such as the emerging Internet 2. Most of these aspects will be hidden from the user.

The advantages and benefits of this invention will be apparent to those skilled in the art from the details of preferred embodiments when concurrently read with the accompanying drawings and claims.

### BRIEF DESCRIPTION OF THE DRAWINGS

The best way to illustrate the system and its components and how they tie together as a whole is by a block diagram.

FIG. 1 is a the block diagram and architecture of the whole system with the major sections broken out and shown as a separate block.

Examples of what the user sees ultimately from the presentation processor are broadly tables or charts and FIG. 2 and FIG. 3 are examples of such output.

FIG. 4 is an example of a request imagined and desired by the user that the user uses screen based drag and drop to create a visual representation (without any data) of how the data is to be presented or the user simply fills in headings for a desired table.

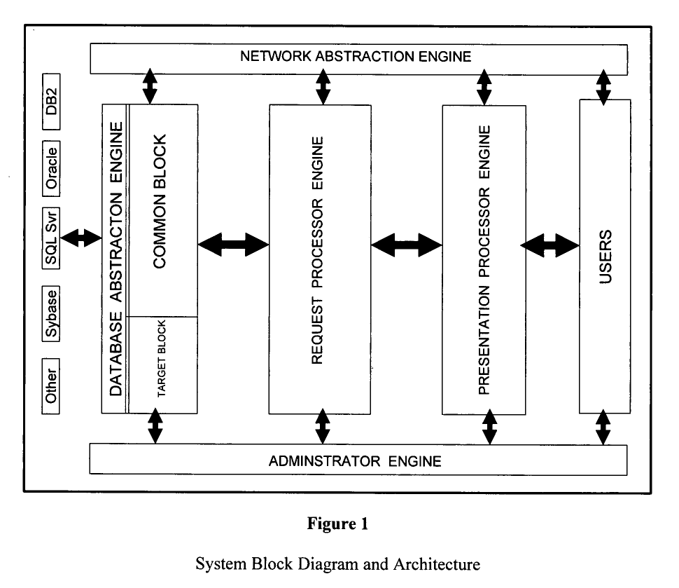

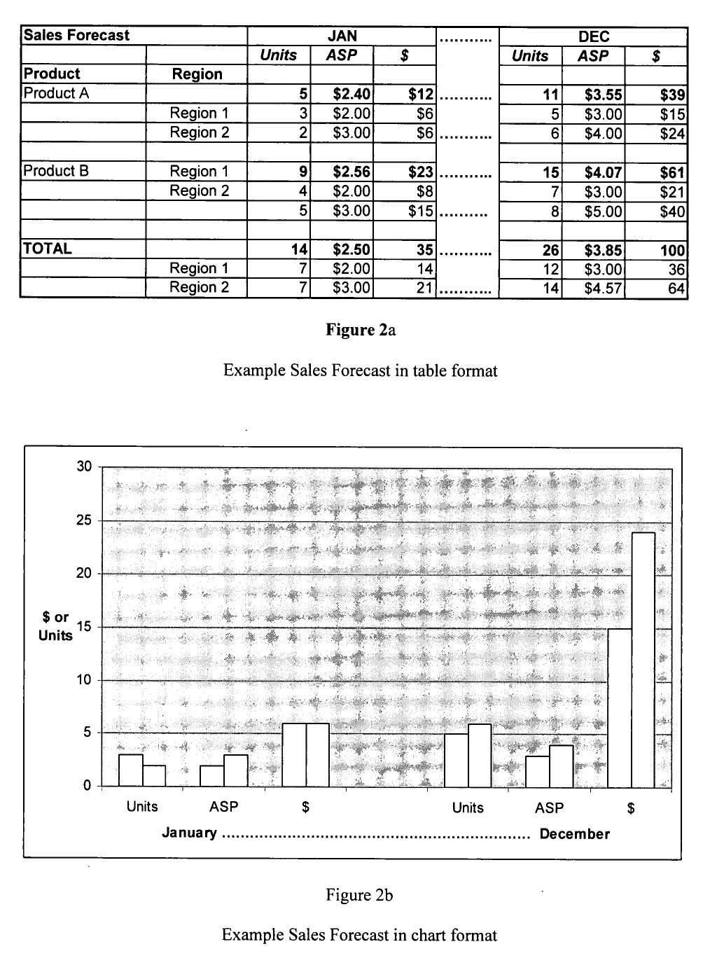

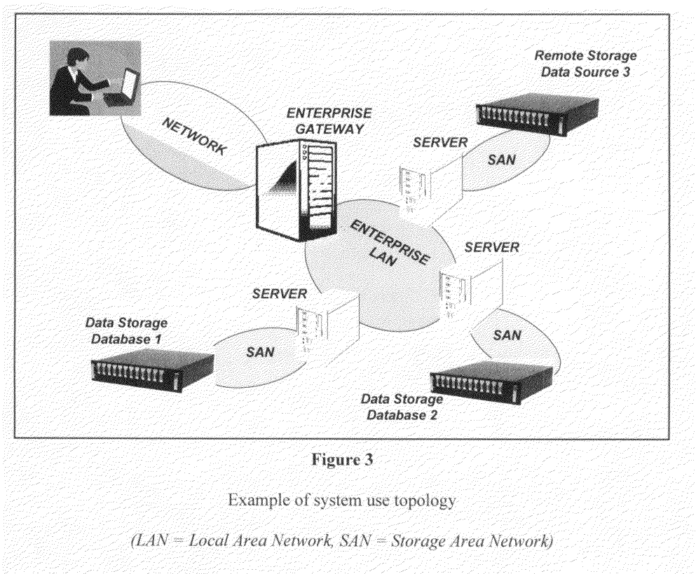

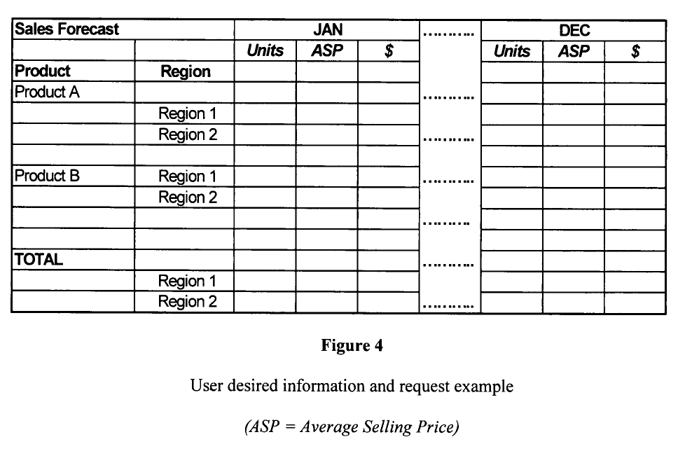

The invention will now be described with reference to its preferred embodiments with use of the drawings mentioned above.

### DETAILED DESCRIPTION OF THE PREFERRED EMBODIMENTS

The detailed description begins with the applicable definitions for the key attributes of the invention

As used herein “user driven” is understood broadly to mean that the user of the system will drive the functioning of the system by the demands placed by the user for acquiring, adapting, operating on and finally formatting and displaying the information to the user at the end-point device that the user employs. The user could be using a computer, mobile phone, iPhone™, PDA (Personal Digital Assistant) or any time of handheld device and the user uses the system to make a request for information that in a format and manner imagined by the user. These are typically in table format or a chart or graph format.

The user can demand to view an existing table, chart, tables, or charts or can create a new request. Therefore, the whole system is user driven. The user makes these requests or demands by use of the block labeled “Presentation Processor Engine” (PPE)

The PPE uses either a graphical interface (visual) and is enabled to use voice (audio) inputs also.

In the graphical interface mode, the user can use on screen tools that can be dragged and dropped to create the format in which the information is to be presented. Standard templates and headings for commonly used elements will be provided for the users convenience. Examples of standard headings are “month”, “revenue”, “week”, “unit price”, “unit cost”, “gross margin”, “lead-time” and many, many others. The system uses an intelligent and adaptive algorithm to prompt the user for table headings and formats based on a simple interpretation of the users' intent, based on the type of table or chart that is being requested from a standard list. For example, if the user is imagining a “sales forecast”, a few simple prompts can make the task simpler for the user such as
Weekly, daily, monthly, hourly . . .
For how many periods—12 months, 20 weeks, . . .
Total sales or a subset such as region (US, International, . . . ), product type or other such options
(This can also be called a process of filtering)

In the case of a table format, the information the user needs to specify is
The visual format of the table
The number of rows and columns
The headings for the rows and columns

FIG. 2a is an example of such a request. The user also has the ability to transpose row and columns at will and the system will respond interactively to such changes. The user can add (ask) new information and change or delete the requested information, the manner in which it is presented at will, and the system will respond interactively. Thus the user can try and experiment with different views and different organization of the data viewed and choose to store or save what is deemed necessary.

The system will also allow the user to transcribe the accessed data into a Microsoft Excel spreadsheet or any other standard third party spreadsheet. In this case, the user has the option of later using the display and viewing tools that are provided with the third party spreadsheet to view the data.

The PPE module is the module of the system that deals with the interface with the user and it is visual and/or auditory. An example of auditory input would be the user speaking
“bring me a table of the monthly sales forecast for xyz product for all of North America for 12 months for the year 2008”

The PPE would respond with the best interpretation of the table and display it on the interface device (computer, PC, notebook computer, workstation, handheld, PDA, iPhone, any other . . . ).

The user can accept the returned format or make edits and changes to ensure the table has the desired contents and the desired display format.

The PPE also allows what are commonly known as “drilling down” or “consolidation” functions. For example if a sales table or chart shows that there is problem with profitability for sales in North America, the user can then invoke prompts for performing “drill down” operations such as
Look at North America sales by product
Look at North America sales by product and by Gross Profit
Look at North America Sales by product and by Gross Profit and by Selling Price
Look at North America Sales by product and by Gross Profit and by Product Cost

Consolidation operations are the opposite of drilldown operations. Examples of consolidation operations are to look at worldwide sales after looking at North American Sales for a certain product and then to consolidate once again into worldwide sales for all products. Again, the user can define consolidation as desired or can invoke the system provided prompts that would prompt for the most common only used and useful consolidated views from the one being viewed.

Tables, and charts or graphs can be stacked one behind the other, closed, linked, viewed deleted or stored. The system will automatically keep links to tables that are linked by data and are related by either consolidation or drill down.

The Request Processor Engine (RPE) accepts requests from the PPE and delivers results to the PPE. The RPE also performs the storage function of displayed information or tables or charts and graphs that are directed to be saved by the user. There is an internal standardized interface between the PPE and the RPE such that modifications and improvements can be made on one without affecting the other.

Thus, there is independence between each of the major functional blocks.

The internal communications between the RPE and the PPE will use a format that is called VSoft Request Format (VRF). This internal format defines all communications between the two blocks. This is a closed format but could also be considered for open sourcing by opening up a set of function calls via a defined set of Application Function calls (APIs) which may be all or a subset of the internal communications format.

The function of the RPE when obtaining requests from the PPE is to transcribe the requested data into a form that can be matched to the target data source which is either a standard database, data warehouse, spreadsheet or any other data source. The RPE will look at the requested information type and an operation that would break it down into the lowest type of atomic element or data entry element. For example if revenue is requested, then it is well known that revenue is in most cases the product of sales price multiplied by unit sales. This breakdown is referred to as a breakdown into the Lowest Operational Cell (LOC). Since the PPE does not have to deal with charts or graphs, this block and subsequent blocks only deal with data as tables. The internal table format is called Vsoft LOC table format and referred to as VLOC tables or the VLOC format. The request VLOC tables are built on the LOCs and where the operators and contexts that are stored are applied to calculate the requested data. Thus, in the previous example unit-sales and sales price per unit are the LOCs and the operator is multiplication to generate revenue.

Thus the RPE will perform all arithmetic, algebraic, logical and, in general, numerous mathematical operations. The format of this will be an internal Structured Query Language form that is mostly ANSI/ISO compliant but with proprietary internal extensions and is called Vsoft Query Language (VQL). Thus the PPE will automatically generate VQL code to be passed on to the Database Abstraction Engine. The first time this is performed, this code will be considered first-pass code or colloquially can be considered “draft code” which is to be finalized later.

Return of data to the RPE from the Database Abstraction Engine (DAE) will be in the form of VLOC tables and the associated VQL code. Thus the RPE can then use the VQL code and the VLOC tables to generate the specific user requested table and pass it on to the PPE for appropriate presentation to the user, which would be tables and/or charts with or without audio and speech processing.

The next functional block to be described is the Database Abstraction Engine (DAE), which is the function that is the interface between the actual data source and the RPE. At the highest level of description, the DAE is functionally broken down into two sub blocks. The first block is referred to as the Common Block and this refers to data processing among the elements that are generally common to almost all databases. The DAE operates on the model that all databases or data sources look alike to a certain degree. For example, if they are relational databases they have tables that are composed of atomic elements. Thus in abstracting information from databases, the DAE can assume that it will be connecting to tables and that these tables will have headers or labels and will be comprised of rows and columns and will have units associated with them such as numbers or currency or dates or could be integers or floating point etc. Thus, the Common Block of the DAE operates on these common elements of data storage and generates SQL code that looks like it would apply to any general database.

The Target Block in the DAE is the functional section that deals with differences from one data source to another. The Target Block is further broken down into sub blocks and each deal with a specific target such as Oracle and its versions, or SQL Server, or Ingress as examples. The Target Block will cover 80% to 90% of the data sources and databases in the industry and has the relevant APIs to be updated as necessary when a new database is targeted. Examples of target specific attributes are limitations on the number of records, the size, width and depth of tables, nomenclature definitions etc. The most important function of all that the Target Block does is to ensure that the eventual SQL code that is used to retrieve data from the source is target compliant. Therefore, the DAE will convert VQL to a target SQL code and retrieve the required information. There is another equally important function that the DAE will perform. This is also part of the abstraction process. Since the user or the system has no information apriori of the table headings of the target database, the user request is expected in commonly used business terminology or jargon, such as sales, cost, weekly or monthly, regional or international etc.

The RPE will break this down, with real time iteration with the user, via the PPE to get this down to specifics such as weekly, international sales in $ for 52 periods or for 2004 fiscal year. The DAE will use the resultant table headings at the atomic level to obtain the exact element of information or the best fit if the DAE cannot determine an exact fit. As an example if the request is for “$ sales” and the target database entry is “revenue” there will obviously not be a match if this is done in a conventional fashion.

Therefore, the DAE has intelligence built in based on human experience and business experience that will check if there are entries that are potentially synonymous. Degrees of synononymity are built in and based on this a probability will be calculated and delivered to the user. Thus, in the above example a 99% probability may be assigned and the user informed. The user can make a decision or get verification and then accept or use subject to verification. The system being a learning system, once accepted or verified that variable will now be mapped as 100% certain.

Thus for a user and for a target database a learning map will be built and refined over time. These maps will be stored at a default location set by the system or in a location specified by the user, subject to almost real-time availability.

Another example for further clarification could be a user request for “$ sales” and the best target entry is “REV”. In this case, the system might return a best-fit value of 50%. Here the user will be prompted to verify and once verified this will be learned.

The manner in which the DAE operates is by essentially functioning like an operating system compiler. The DAE will parse SQL code and compile a list of atomic database entries that are required. These entries will have synonyms associated with them. Then an intelligent match is done on the target database to get the best match for these entries. Subsequently, the SQL operations are performed and the tables, the variables, and their certainties are returned to the RPE. If there are a number of uncertain elements, it may take more than one iteration to converge as the user may decide to try a different label instead of doing a separate verification through the IT department or the database administrator. Hence there are three major operations, which are parsing, interpreting and compiling.

As used herein parsing is meant to mean an operation where the SQL code is reviewed once or multiple times by the software to generate the required information. As used interpreting is used to mean the intelligent and adaptive process by which the system determines the best fit of the data that is sourced to the data that is requested. It is also used to mean the interpretation of the system as to what is being requested by the user. As used herein adaptive is used to mean the process of adapting the system and the data and the method of presentation to the users' request.

The next functional block described is the Network Abstraction Engine (NAE). The function of this block is to insulate the system from the particular network and connectivity system being used. The system functions by communicating with the user through a network and a front end such as a browser and connects to the data sources also by a network and the system will also be able to run on servers remotely or be distributed. For example, a logical distribution if distributed is that the PPE runs at the user end and the rest run on the server. Multiple but finite distribution choices are provided at the time of installation. For such flexibility, the system will encounter various networks such as wireless networks, wired or wireless LANs and also other types of networks such as some Wide Area Networks (WAN) or SANs or the general Internet. The NAE ensures that the tool can function with any such networks and the internal workings are abstracted to the TCP/IP (Transmission Control Protocol/Internet Protocol) sessions. However, the design also allows for IP v6 compatibility. APIs are also designed into the system such that most future networks or any specialized networks can be later included by use of the API calls. Alternatively, the APIs can be used for customizing the protocol. Encryption will be supported in the communications in and out of the system.

Because of the NAE, the user can use the system remotely through the Internet or a VPN or a private WAN. The user can use a typical browser in this case and the NAE provides all the functionality needed. The same user can later log on at a coffee shop and use the system and later back in the office, can use the system on the company's intranet or Ethernet LAN. The access can be from a Personal Computer (typically) or can also be from a PDA or a wireless or mobile phone, iPhone or WiFi or WiMax phone, assuming the user's device supports a browser and has the appropriate functionality. On certain handheld devices, the functionality and the viewing options may be limited by the limitations of the viewing and communicating device itself.

Finally, the last functional block to describe is the Administrator Engine (AE). The first major function of this block is performing all the required and common access functions such as setting access security levels and permissions. For example, only certain persons who have access will be allowed to actually write into a database or data source and change a table entry. If for example, a user's analysis results in the revelation that certain data in the database is erroneous, then it is necessary that this be corrected. Such an action will only be permitted for a very select and limited set of users.

The second major function of the AE is administering the contract and billing arrangement with the customer. A number of options are considered in the arrangement with the customer and certain customers may have paid for a fixed number of simultaneous users whereas another may have negotiated and unlimited use license at a particular site and so on. The AE has all the billing and customer options and keeps track and enforces the installed and agreed option. The AE also automatically generates the invoices and any documentation required and agreed upon. The arrangements can be user based, subscription based, license based as illustrative examples.

The AE block also keeps track of revisions, versions, bug fixes and specific customer oriented enhancements.

The AE block also monitors performance metrics such as the response time, and other usage metrics and these are recorded and reported to the user and also to the vendor of the product, which at the time of the application is Vsoft. The AE block also manages all back up and archiving operations, which are selected by the user at installation time and can be changed anytime by the user.

All of the tracking, reporting and administrative functions of the AE block are automatically generated and distributed. Examples are invoices, revision reports, usage reports, performance reports and monitoring data.

While the present invention has been described in connection with what is presently considered to be the most practical and preferred embodiments, it is to be understood that the invention is not limited to the disclosed embodiments, but is intended to cover various modifications and equivalent arrangements included within the spirit and the scope of the appended claims.

Microsoft Excel, SQL Server, SAP, Oracle, DB2, Sybase, KPMG, Business Objects, Crystal Reports and iPhone are trademarks of their respective companies.

I claim:

1. A User Driven, Interactive, Adaptive, Intelligent Business Management, or Business Intelligence and Data Viewing Information System or Tool that is Database or Data Source Abstracted and Independent, and is Network and Connectivity Abstracted and Independent with Automated Administrative Support, with learning ability. A system that is comprised of the five major functional blocks a) A User Facing Presentation Processor Engine which is a means of interacting with the User, b) a Request Processor Engine that processes the User's requests and returns them, which is a means of processing the User's requests and also for returning data to said User Facing Presentation Processor c) a Database Abstraction Engine that is a means of abstracting and insulating the User from the physical database or data source thus making said system Database and Data Source independent, d) a Network Abstraction Engine that is a means of abstracting and insulating the User from the specific network or connectivity method used thus making said system Network and Connectivity independent and e) an automated Administrator Engine that is a means of managing all the administrative functions conventionally performed by separate tools or manual intervention.

2. A system according to claim 1, but without partitioning into the separate functional blocks but delivering essentially the same features, functionality and capability in total.

3. A system according to claim 1, but partitioned into a different set of functional blocks that deliver essentially the same features, functionality and capability in total.

4. A system according to claim 1 in which the User Facing Presentation Processing Function is a means of interacting with the User visually, where visual presentations are enabled to be viewed in tables, charts or graphs and other typical business graphics that can be manipulated and controlled edited, changed, modified by the user, including but not limited to drill down, consolidation, stacking, overlaying, filtering, rotating, inverting, performing algebraic and mathematical operations, formatting, windowing, storing, retrieving, transposing, emailing, migrating to other software tools such as Microsoft Excel or PowerPoint where the User can also employ enablement such as drag and drop elements, prompts and other visual aids that can be real time or non real time.

5. A system according to claim 1 in which the User Facing Presentation Processing Function is a means of interacting with the User with audio that combines speech recognition and speech synthesis.

6. A system according to claim 1 in which the User Facing Presentation Processing Function is a means of interacting with the User both visually as described in claim 4 and with audio as described in claim 5.

7. A system according to claim 1 in which the User Facing Presentation Processing Function has an independent format for communications between the presentation processing function and the other functional blocks and where third parties can access this interface by means of a set of Application Programming Interfaces (APIs).

8. A system according to claim 1 in which the User Facing Presentation Processing Function has an independent format for communications between the presentation processing function and the other functional blocks and where third parties can access this interface by means of a set of Application Programming Interfaces (APIs).

9. A system according to claim 1 that has a Request Processing Function where such a function is the interface between the User and the Data Abstraction Function and the means of independence is through the automatic generation of an internal Structured Query Language (SQL) that uses standard SQL conventions and notations and new extensions.

10. A system according to claim 1 that has a Request Processing Function where such a function takes the user information and breaks it down automatically into the lowest atomic level or the lowest fundamental element of data such that all other data can be built up from the use of such an atomic level elements.

11. A system according to claim 1 that has a Request Processing Function where such a function takes the retrieved information from the database or the data source via an abstraction function and applies the internal Structured Query Language when the data is at the atomic level, to transform it into the User requested data.

12. A system according to claim 1 that has a Database or Data Source Abstraction or Extraction Function where the function is able to automatically generate the Structured Query Language (SQL) code or any other type of code required for the target database or data source.

13. A system according to claim 1 that has a Database or Data Source Abstraction or Extraction Function where the function is able to automatically generate the Structured Query Language (SQL) code or any other type of code required for the target database or data source and can support multiple and diverse data sources or databases.

14. A system according to claim 1 that has a Database or Data Source Abstraction or Extraction Function that has an intelligent means of matching user generated information to those in the database or data source.

15. A system according to claim 14 where such an intelligent matching has an algorithm that generates the probability of a match.

16. A system according to claim 1 that has a Database or Data Source Abstraction or Extraction Function that has method of abstraction that is two pronged, where the first prong generates SQL code that is common among all or most databases and data sources and the second prong generates the code that is specific to the target database or data source where such combined code is the external facing code and where the final code is standard code for that target database or data source.

17. A system according to claim 1 that has a Database or Data Source Abstraction or Extraction Function that has method of abstraction that is two pronged, where the first prong generates SQL code that is common among all or most databases and data sources and the second prong generates the code that is specific to the target database or data source and which automatically converts the external facing code to a common internal facing code.

18. A system according to claims 13, 14, 15,16, 17 that uses a compiler like parsing process that can include a single or multiple, iterative parsing scheme with increased learning with each pass.

19. A system according to claim 1 that has a Database or Data Source Abstraction or Extraction Function where the automatic generation and mapping and conversion of SQL or similar database related code where the match between the user request and the target data is intelligently estimated by employing string matching with contextual information and contextual estimation and matching, estimation and matching from table entry unit values and all other forms of matching that are algorithmically exactly like or similar to a human process of matching, similar to language translation when there is not an exact match.

20. A system according to claim 1 that has a Database or Data Source Abstraction or Extraction Function that is modular and extensible whereby extensions, additions or modifications can be made to include future databases and associated query language coding formats, commands, syntax, semantics and abstractions.

21. A system according to claims 1 through 20 where the functions within the Request Processor Engine and the Database Abstraction Engine can be combined or separated, or implemented in a different manner to achieve essentially the same result.

22. A system according to claim 1 that has a Network or Connectivity Facing Network Processing and Abstraction Function that incorporates an intelligent layer of mapping and translation that adapts to the particular means of connectivity and can function within all layers of the OSI (Open System Interconnection) stack above the physical layer. This includes the data link layer all the way to the presentation layer, as necessary for the system to enable the user the required and necessary connectivity to all software and hardware components in the network topology.

23. A system according to claim 1 where the Administrative Support Function has the means and methodology embedded to generate all financial tasks including but not limited to monitoring and enforcing the terms of the customer contract and usage agreements, generating all invoices, tracking and maintaining updates, bug and maintenance reports, and where such a system has the means to automatically contact the client or system supplier for routine reports and also other alerts, and where such a function enforces security and access and monitors and enforces and reports on security and all security and access related aspects.
